(19) United States
(12) Patent Application Publication
(10) Pub. No.: US 2006/0081603 A1
(43) Pub. Date: Apr. 20, 2006

(54) Fluid heater

(76) Inventor: Gijsbert Eimert Van Der Meulen, Pretoria (ZA)

Correspondence Address: Gijsbert Eimert Van Der Meulen, Breyerlaan 1221, Waverley, Pretoria, 0186, ZA

(21) Appl. No.: 10/501,181

(22) PCT Filed: Aug. 15, 2003
(86) PCT No.: PCT/ZA03/00112

§ 371 Date: Jul. 9, 2004

(30) Foreign Application Priority Data
Jan. 28, 2003 (ZA) 2003/0754

(51) Int. Cl. H05B 3/02

(52) U.S. Cl. 219/478

(57) ABSTRACT

In most households the electrical geyser is one of the major electricity consumers. This patent provides an alternative method of heating a fluid typically water, only using electricity while water is flowing. The invention provides a method of heating a fluid which includes the step of passing said fluid along a flow passage defined within a tubular electrically resistive heating element. An effective and electricity saving means for heating a fluid particularly water for industrial and/or domestic purposes is provided. A current regulator may be added to the heating element to heat a fluid particularly water to specific temperature for specified flowrate.

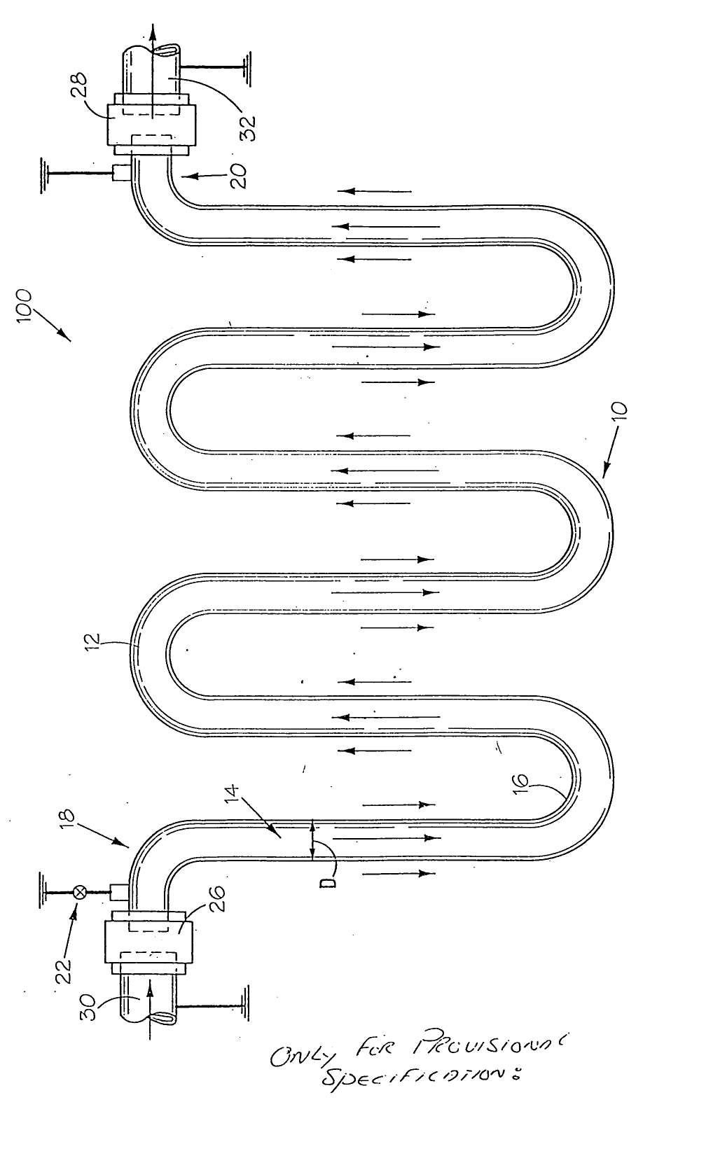

THIS INVENTION relates to a method of heating a fluid and to a fluid heater. The invention extends to a fluid flow line.

According to one aspect of the invention, there is provided a method of heating a fluid, which method includes the step of passing said fluid along a flow passage defined within a tubular electrically resistive heating element electrically connected to an electrical current source.

According to another aspect of the invention, there is provided a fluid heater, which includes a tubular electrically resistive heating element which is connected or connectable to an electrical current source, the heating element defining an internal fluid flow passage through which a fluid to be heated can pass.

The heating element may be of serpentine form.

The internal diameter of the heating element may vary according to requirements.

The heater may include switch means for selectively switching the heating element between an on and an off condition.

The heater may include valve means for selectively permitting or inhibiting flow of a fluid along the flow passage. The switch means may be displaced to and remain in its on condition only while fluid is flowing along the flow passage.

The heating element may be thermally insulated. The heater may include an insulated housing accommodating the heating element.

According to still another aspect of the invention there is provided a fluid flow line which includes a fluid heater as hereinbefore described, the heater being connected in flow communicating with fluid supply means at an upstream end of the flow passage and with fluid discharge means at a downstream end of the flow passage, the fluid supply means, flow passage and fluid discharge means together defining a fluid flow path.

The flow line may include valve means, including a valve element disposed in the flow path, for selectively permitting or inhibiting flow of fluid along the flow path.

The flow line may include switch means for selectively switching the heating element between an on condition, in which it is electrically connected to an electrical power source, and an off condition, on which it is disconnected from the power source.

The fluid discharge means may include a tap.

The switch means may be in the form of a timer switch such that predetermined times at which the heating element will be switched to an on or to off condition may be pre-set and switching will automatically be triggered at such times.

The invention will now be described, by way of example, with reference to the accompanying drawing, which shows a schematic diagram of part of a fluid flow line 100 in accordance with the invention.

The fluid flow line 100 includes a fluid heater, generally indicated by reference number 10.

In the embodiment shown, the fluid heater 10 is a continuous flow liquid heater 10. The heater 10 includes a tubular heating element 12 defining a flow passage, generally indicated by reference number 14. The heating element 12 is of an electrically resistive material as for example, the material used for kettle/stove heating elements, and is configured to be electrically connectable to an electrical current supply.

The heating element 12 defines an electrical current flow path 16. In use, a potential difference is applied across ends 18, 20 of the heating element 12 causing electrical current to flow and the resistive material of the element 12 to heat up. Liquid, typically water, is passed along flow passage 14 defined within the tubular heating element 12 from an upstream end 18 towards a downstream end 20 thereof and is heated on contact with the internal surface of the element 12.

The fluid heatert 10 includes switch means 22 for selectively switching the heating element 12 between an on and an off condition. In one embodiment of the invention, the switch means 22 is provided by a timer switch which permits predetermined times at which the heating element 12 is to be switched between its on and off conditions to be preset and which automatically triggers switching at such times.

The heater 10 may further include valve means (not shown) for selectively permitting or inhibiting flow of fluid along the flow passage 14.

The fluid heater 10 is typically installed to define part of a fluid flow line of a domestic or industrial water supply system. In such a system, the heater 10 is connected to water supply means (not shown) via a cold water supply pipe 30 at its upstream end 18 and to hot water discharge means (not shown) via a hot water discharge pipe 32 at its downstream end 20. The cold water supply pipe 30 and hot water discharge pipe 32 are typically earthed. Accordingly, the heating element 12 is electrically isolated from the cold water supply pipe 30 and the hot water discharge pipe 32 by electrical isolators 26, 28, respectively. The isolators 26, 28 are water-tight. The water discharge means may include a tap (not shown) via which hot water may be discharged/dispensed for use.

It will be appreciated that an internal diameter D of the heating element 12 will vary according to requirements. Typically, the internal diameter D will be similar to that of the supply and discharge pipes 30,32.

The fluid heater 10 is typically housed within an insulated casing (not shown) thereby to limit the risk of accidental touching of the heating element 12 by a user.

The length of the heating element 12 may vary according to requirements.

In use, the valve means is opened before the switch means 22 is switched from an off to an on condition thereby to prevent pressure build-up in the flow passage 14. Switch means 22 is switched to an off condition before the valve means is closed, similarly to prevent pressure build-up in the flow passage 14 as water is heated and expands.

The Inventor believes that the heater 10 in accordance with the invention will provide an effective means for heating fluid/liquid, particularly water, for industrial and/or domestic purposes.

1. This invention provides an effective and electricity saving means for heating a fluid particularly water for industrial and/or domestic purposes.

2. If a current regulator is added to the heating element, this invention provides a method to continuously heat up a fluid particularly water to a specific temperature for a specified flowrate.
